(19) United States
(12) Patent Application Publication
(10) Pub. No.: US 2004/0225738 A1
(43) Pub. Date: Nov. 11, 2004

(54) Methods, systems and computer program products for replicating servers and network traffic for problem determination and/or tuning

(76) Inventor: Dipak M. Patel, Morrisville, NC (US)

Correspondence Address: MYERS BIGEL SIBLEY & SAJOVEC, PO BOX 37428, RALEIGH, NC, 27627, US

(21) Appl. No.: 10/435,074

(22) Filed: May 9, 2003

(51) Int. Cl. G06F 15/173

(52) U.S. Cl. 709/226

(57) ABSTRACT

Operation of an instance of a server application is replicated by replicating the instance of the server application to provide a replica server. Network traffic to the instance of the server application from a network associated with the instance of the server application is forward to the replica server and network traffic from the replica server is filtered so as to prevent network traffic from the replica server from reaching the network associated with the server. Network traffic may also be forwarded to the instance of the server application from the network associated with the instance of the server application.

### FIELD OF THE INVENTION

The present invention relates to networks and more particularly to problem determination and/or tuning of networked servers.

### BACKGROUND OF THE INVENTION

With the increased interactions between data processing systems, for example, in distributed computing, the complexities of problem diagnosis and tuning of applications and/or systems has increased. One conventional technique for tuning a system or for problem determination has been to utilize a test system that is identical to a production system to repeat the problem and/or to try various tuning adjustments. In addition to potential problems with availability, cost and maintenance of such test systems, it may also be difficult to provide an artificial network load to the test system that provides meaningful results.

For example, in order to diagnose a problem or tune a server, the network load presented to the test system may need to be substantially identical to the real world load of the system being simulated by the test system. Otherwise, inaccurate or even misleading results may be obtained. Simulation of the real world load may be particularly difficult for servers where the level of transaction and/or types of transactions varies with the time of day. Also, interdependencies or interactions between systems may be overlooked or may be unknown and, therefore, not reflected in the test system.

In light of the difficulties using test systems for tuning and/or problem diagnosis, it may be time consuming and/or expensive to utilize test systems for tuning and/or problem diagnosis. Furthermore, the accuracy of the results may depend on the ability to accurately simulate both real world traffic and the system being simulated. Accordingly, users may avoid such uses which may further exacerbate problems as tuning or preventative maintenance may be put off until after a failure occurs.

### SUMMARY OF THE INVENTION

Embodiments of the present invention provide methods, systems, and computer program products for replicating operation of an instance of a server application by replicating the instance of the server application to provide a replica server. Network traffic to the instance of the server application from a network associated with the instance of the server application is forward to the replica server and network traffic from the replica server is filtered so as to prevent network traffic from the replica server from reaching the network associated with the server. Network traffic may also be forwarded to the instance of the server application from the network associated with the instance of the server application.

In further embodiments of the present invention, the network traffic forwarded to the replica server is stored, for example, for subsequent playback to the replica server or subsequent off-line analysis. Storing the network traffic forwarded to the replica server may also include storing timing information associated with the network traffic. The stored network traffic may also be played back to the replica server utilizing the stored timing.

In additional embodiments of the present invention, a debug mode for replication of the instance of the server application is selected. In such a case, replicating the instance of the server application to provide a replica server, forwarding to the replica server, network traffic to the instance of the server application from a network associated with the instance of the server application and filtering network traffic from the replica server so as to prevent network traffic from the replica server from reaching the network associated with the server are automatically carried out if debug mode is selected.

In still further embodiments of the present invention, characteristics of the replica server are modified without modifying characteristics of the instance of the server application. The modifications to the characteristics of the replica server are selectively propagated to the instance of the server application based on an effect of the modifications on the operation of the replica server in response to the forwarded network traffic.

In other embodiments of the present invention, forwarding to the replica server and forwarding to the instance of the server application and filtering network traffic from the replica server are provided by generating a proxy agent that receives network traffic from the network to the instance of the server application and forwards the received network traffic to the instance of the server application and the replica server and receives network traffic from the instance of the server application and the replica server. The proxy agent also filters out the network traffic received from the replica server and forwards the network traffic received from the instance of the server application to the network.

In particular embodiments of the present invention, a front-end proxy agent is generated that forwards requests to the instance of the server application and the replica server and filters responses from the instance of the server application and the replica server. A back-end proxy agent is also generated that filters requests from the instance of the server application and the replica server and forwards responses to the instance of the server application and the replica server.

In yet other embodiments of the present invention, forwarding to the replica server, forwarding to the instance of the server application and filtering network traffic from the replica server includes forwarding requests to the instance of the server application to the replica server and the instance of the server application. Responses to requests from the instance of the server application are also forwarded to the replica server and the instance of the server application. Responses from the replica server and requests from the replica server are filtered out of the network traffic.

In additional embodiments of the present invention, forwarding to the replica server and to the instance of the server application is preceded by security processing the network traffic so as to provide unencrypted network traffic. The unencrypted network traffic is forwarded to the replica server and to the instance of the server application. Additionally, filtering network traffic from the replica server may be carried out prior to security processing of the network traffic from the replica server.

As will further be appreciated by those of skill in the art, while described above primarily with reference to method aspects, the present invention may be embodied as methods, apparatus/systems and/or computer program products.

### BRIEF DESCRIPTION OF THE DRAWINGS

FIG. 1 is a block diagram of a data processing system suitable for use in a server replication system according to embodiments of the present invention;

FIG. 2 is a more detailed block diagram of a server replication system according to embodiments of the present invention;

FIG. 3 is a block diagram of a system incorporating a replicated server according to embodiments of the present invention;

FIG. 4 is a flowchart illustrating operations for server replication according to embodiments of the present invention; and

FIG. 5 is a flowchart illustrating operations of a client-side and/or back-end proxy for server replication according to embodiments of the present invention.

### DETAILED DESCRIPTION OF THE INVENTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one of skill in the art, the present invention may be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Embodiments of the present invention provide for replication of a server and network traffic associated with the server so as to allow, for example, problem determination and/or tuning of the server that is replicated. Embodiments of the present invention may provide real world traffic to a replica of a server instance that may be used, for example, to determine the cause of a problem or to test tuning of the server instance without disruption to the operation of the server instance. When a fix or tuning improvement is made, these changes to the replica server may be propagated back to the replicated server.

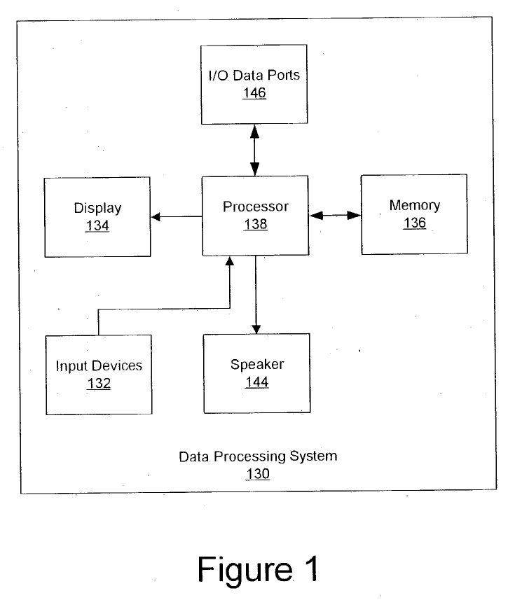

Various embodiments of the present invention will now be described with reference to the figures. FIG. 1 illustrates an exemplary embodiment of a data processing system 130 suitable for a server and network traffic associated with the replicated server in accordance with embodiments of the present invention. The data processing system 130 typically includes input device(s) 132 such as a keyboard or keypad, a display 134, and a memory 136 that communicate with a processor 138. The data processing system 130 may further include a speaker 144, and an I/O data port(s) 146 that also communicate with the processor 138. The I/O data ports 146 can be used to transfer information between the data processing system 130 and another computer system or a network. These components may be conventional components, such as those used in many conventional data processing systems, which may be configured to operate as described herein.

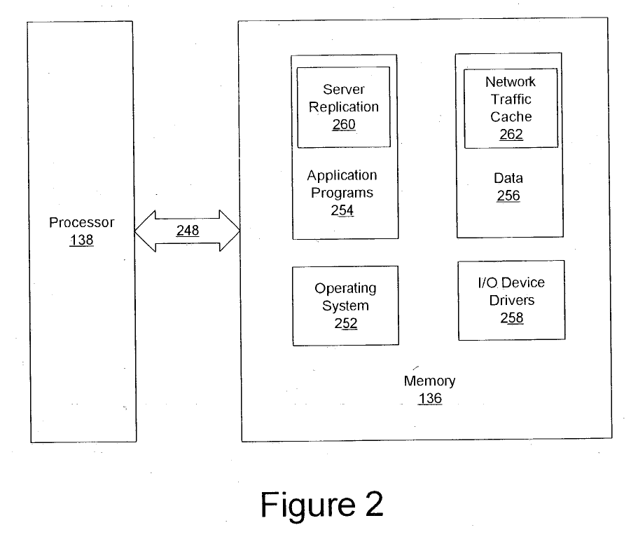

FIG. 2 is a block diagram of data processing systems that illustrates systems, methods, and computer program products in accordance with embodiments of the present invention. The processor 138 communicates with the memory 136 via an address/data bus 248. The processor 138 can be any commercially available or custom microprocessor. The memory 136 is representative of the overall hierarchy of memory devices containing the software and data used to implement the functionality of the data processing system 130. The memory 136 can include, but is not limited to, the following types of devices: cache, ROM, PROM, EPROM, EEPROM, flash memory, SRAM, and DRAM.

As shown in FIG. 2, the memory 136 may include several categories of software and data used in the data processing system 130: the operating system 252; the application programs 254; the input/output (I/O) device drivers 258; and the data 256. As will be appreciated by those of skill in the art, the operating system 252 may be any operating system suitable for use with a data processing system, such as OS/2, AIX or System390 from International Business Machines Corporation, Armonk, N.Y., Windows95, Windows98, Windows2000 or WindowsXP from Microsoft Corporation, Redmond, Wash., Unix or Linux. The I/O device drivers 258 typically include software routines accessed through the operating system 252 by the application programs 254 to communicate with devices such as the I/O data port(s) 146, the data storage 135 and certain memory 136 components. The application programs 254 are illustrative of the programs that implement the various features of the data processing system 130 and preferably include at least one application which supports operations according to embodiments of the present invention. Finally, the data 256 represents the static and dynamic data used by the application programs 254, the operating system 252, the I/O device drivers 258, and other software programs that may reside in the memory 136.

As is further seen in FIG. 2, the application programs 254 may include a server replication module 260. The server replication module 260 may carry out the operations described herein for replicating a server and network traffic associated with the replicated server. The data portion 256 of memory 136, as shown in the embodiments of FIG. 2, may, optionally, include a network traffic cache 262. The network traffic cache 262 may be utilized by the server replication module 260 to provide playback of network traffic associated with a problem or for tuning of the replicated server.

While the present invention is illustrated, for example, with reference to the server replication module 260 being an application program in FIG. 2, as will be appreciated by those of skill in the art, other configurations may also be utilized while still benefiting from the teachings of the present invention. For example, the server replication module 260 may also be incorporated into the operating system 252, the I/O device drivers 258 or other such logical division of the data processing system 130. Thus, the present invention should not be construed as limited to the configuration of FIG. 2 but is intended to encompass any configuration capable of carrying out the operations described herein.

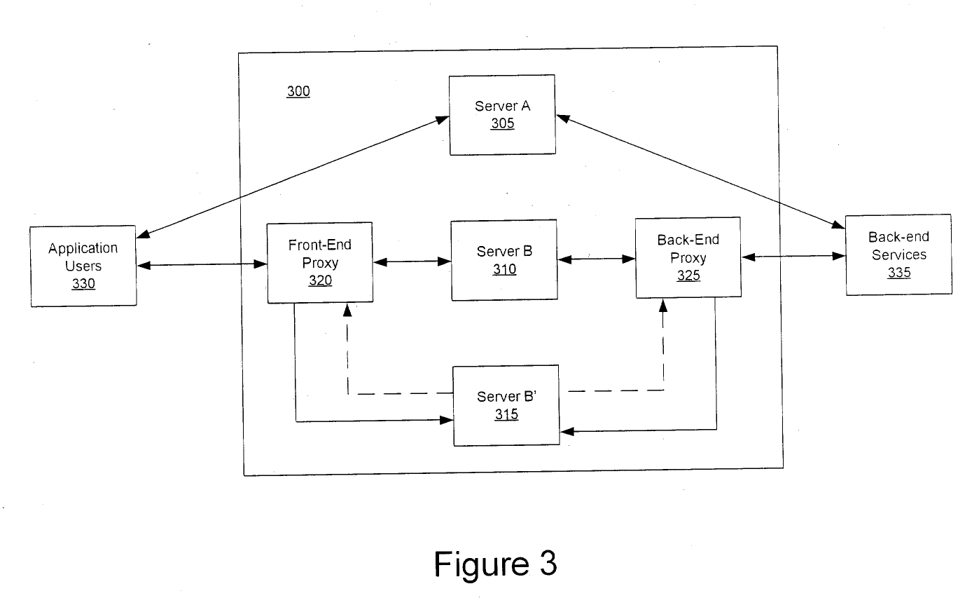

FIG. 3 is a block diagram of a system incorporating a replicated server according to embodiments of the present invention. As seen in FIG. 3, a node 300 of a network, such as a server or other data processing system, may have a plurality of server instances 305, 310, executing at the node 300. For example, as illustrated in FIG. 3, the node 300 includes a first server application, Server A, 305, such as a WebSphere Application Server from International Business Machines Corporation, Armonk, N.Y., and a second server application, Server B, 310.

The Server A 305 and the Server B 310 communicate with application users 330 and may also communicate with back-end services 335 over one or more networks, such is the Internet, an intranet, an extranet or the like. As used herein, “back-end services” refers to services that are accessed by a server application as opposed to directly from an end-user. Such accesses may be transparent to a user or may be initiated by a user. Accordingly, communication sequences with back-end services are, typically, initiated by the server A 305 or the server B 310, whereas communication sequences with the application users 330 are typically initiated by the application users 330.

Network traffic (e.g. Internet Protocol (IP) packets or datagrams or Asynchronous Transfer Mode (ATM) cells) is considered “incoming” when it is received by the node 300 and is considered “outgoing” when it is sent from the node 300. Thus, for example, an incoming packet may be received from a network by the node 300 from the application users 330 or from the back-end services 335. Likewise, an outgoing packet may be transmitted to a network by the node 300 for deliver to the application users 330 or the back-end services 335.

As is further illustrated in FIG. 3, the node 300 also includes a replica of the server B 310 that is provided as the server B′ 315. The server B′ 315 may be an exact copy of the server B 310 and may be replicated using known techniques for replicating servers. However, according to particular embodiments of the present invention, when the server B 310 is replicated, a “debug” mode may be selected that also automatically generates a proxy or proxies for forwarding and filtering packets to/from the replica server B′ 315. For example, the front-end proxy 320 and the back-end proxy 325 may be provided to forward incoming and outgoing network communications to/from the original instance of the server B 310 and to forward network communications to and filter out network communications from the replicated server instance server B′ 315. As will be appreciated by those of skill in the art in light of the discussion herein, as used herein, the term “forwarding” to a network or application refers to directly forwarding and/or forwarding through one or more intermediaries, such a subsequent processes and/or devices. For example, if secure network traffic is utilized, the packets may be forwarded to a security process rather than directly to a network. Optionally, the front-end proxy 320 and/or the back-end proxy 325 also cache the incoming and/or outgoing network traffic and timing information associated with the network traffic so as to allow for subsequent analysis and/or playback to the replica server B′ 315.

While the replica server B′ 315 is illustrated in FIG. 3 as being instantiated at the same node 300 as the server B 310 that is replicated, the replica server B′ 315 could also reside on a different node and/or processing system. However, having both the server B 310 and the server B′ 315 on the same node and/or data processing system may increase the likelihood that the server B′ 315 accurately represents the operations of the server B 310. Thus, in particular embodiments of the present invention, the server B 310 and the server B′ 315 reside at the same node of a network and in further embodiments of the present invention, the server B 310 and the server B′ 315 reside on the same data processing system.

Furthermore, while the proxies 320 and 325 are also illustrated as residing at the node 300, they, likewise, could reside at a different node, data processing system and/or network device. For example, the network traffic to and from the node 300 could be monitored by a second node through port mirroring and the replica server B′ 315 and the proxies 320 and 325 could reside at the second node. In such a case, the proxies would not need to forward data to the server B 310 but would only serve to selectively forward data to the replica server B′ 315 and filter out traffic from the replica server B′ 315. Also, while two proxies 320 and 325 are illustrated in FIG. 3, a single proxy could be provided if that proxy had access to the network traffic for the server B 310. Similarly, more than two proxies could also be provided, for example, if multiple network paths were utilized by the server B 310. Accordingly, embodiments of the present invention should not be construed as limited to the particular configuration illustrated in FIG. 3 but may be provided by any configuration capable of carrying out the operations described herein.

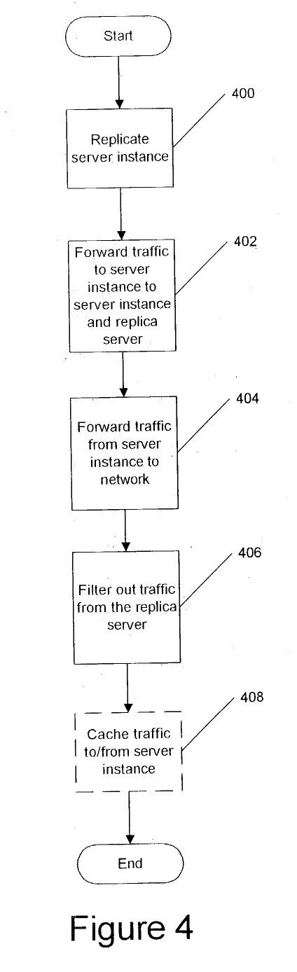

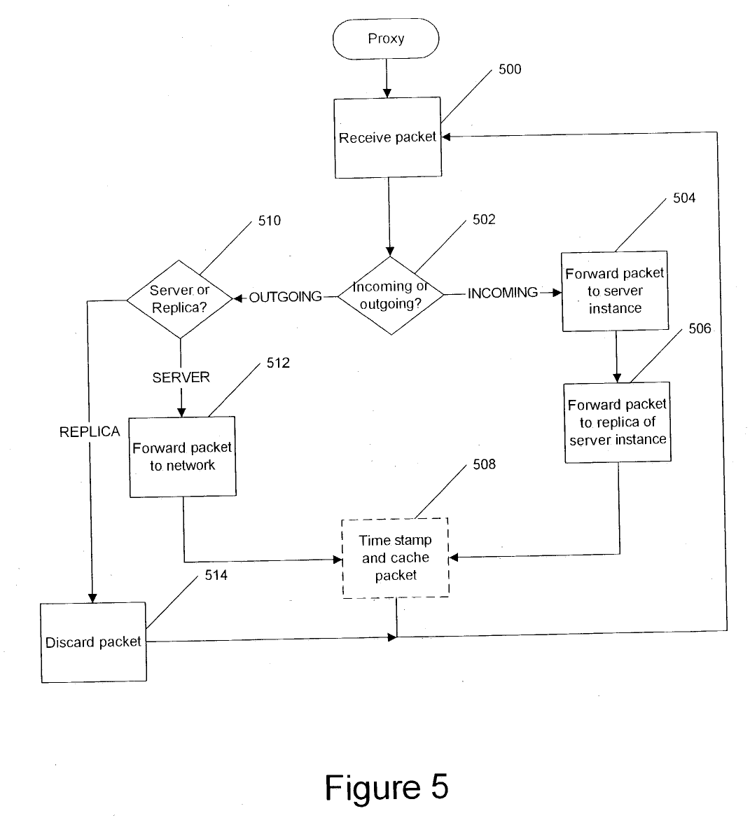

Operations according to embodiments of the present invention will now be described with reference to the flowcharts of FIGS. 4 and 5. In particular embodiments of the present invention, the operations illustrated in FIG. 4 are provided through the server replication module 260 of FIG. 2. As seen in FIG. 4, an instance of a server to be replicated, such as server B 310, is replicated (block 400), for example, to provide server B′ 315. This replication may be automatically carried out and, may also include the automatic creation of proxies or other modules for controlling the flow of network traffic associated with the replica server. For example, as mentioned above, when the server is replicated a “debug” mode may be selected that automatically provides the necessary components and setup for controlling the flow of network traffic as described herein.

As is further Illustrated in FIG. 4, network traffic to the server instance that is replicated, server B 310, is forwarded to the both the server that is replicated, server B 310, and the replica server, server B′ 315 (block 402). Network traffic from the server instance that is replicated, server B 310, is forwarded to the appropriate network (block 404). Network traffic from the replica server instance, server B′ 315, is filtered out and is not forwarded to the appropriate network (block 406). In this way, the replica server instance, server B′ 315, may operate in the same manner as the replicated server instance, server B 310, without disrupting operations of the replicated server instance, server B 310, or of the users using the replicated server, server B 310, or the services used by the replicated server, server B 310. Furthermore, the amount of network traffic on the associated networks may not be increased by the simulation of the replicated server instance, server B 310, by the replica server instance, server B′ 315.

As is further illustrated in FIG. 4, optionally, the network traffic to and/or from the replicated server instance, server B 310, may be cached for subsequent playback to the replica server instance, server B′ 315. If network traffic is cached, timing information associated with the network traffic may also be stored so as to allow for playback of the network traffic with timing similar to the original timing of the network traffic. For example, a time stamp may be associated with the network traffic when it is cached and the time stamp used to maintain the timing relationship between network traffic. Such a caching and thee stamp system may also be useful even if playback is not desired. For example, if the replica server is used for tuning, the timing of the network traffic generated by the replica server could be compared to the original timing to determine if changes to the replica server have improved the performance of the replica server.

FIG. 5 illustrates operations of a proxy that may provide the network traffic control illustrated in FIG. 4. The operations of the proxy illustrated in FIG. 5 may be carried out, for example, by the front-end proxy 320 and/or the back-end proxy 325 illustrated in FIG. 3. As seen in FIG. 5, the proxy receives a network packet (block 500) and determines if the network packet is an incoming packet or an outgoing packet (block 502). Such a determination may be made, for example, by evaluating the destination and/or source address of the packet. For example, the destination address of the packet may be compared to a list of addresses associated with the replicated server instance, for example, the server B 310, and the replica server instance, for example, the server B′ 315. If the destination address is not in the list, then the packet is an outgoing packet. If the destination is in the list, then the packet is an incoming packet. Alternatively or in addition, the source address of the packet may be evaluated and compared to a list of addresses associated with the replicated server instance, for example, the server B 310, and the replica server instance, for example, the server B′ 315. If the source address is on the list, the packet is an outgoing packet. If the source address is not on the list, the packet is an incoming packet.

Furthermore, in particular embodiments of the present invention, the proxies 320 and 325 may be placed after any security functions are performed for incoming packets and before any security functions are performed for outgoing packets. By placing the proxies before encryption and after decryption, the evaluation of the source and/or destination may be provided without having to provide encryption/decryption capabilities in the proxy itself. Furthermore, by filtering out network packets before encryption and forwarding network packets after decryption, the load seen by any encryption/decryption process may be unaffected by inclusion of the replica server. However, in such cases, the security of the packets forwarded to the replica server should be maintained in a manner similar to the security of the packets forwarded to the replicated server.

If the packet is an incoming packet (block 502), the packet is forwarded to the replicated server instance, the server B 310 (block 504). The packet is also forwarded to the replica server instance, the server B′ 315 (block 506). Optionally, the packet may be time stamped and cached (block 508), for example, in the network traffic cache 262 of FIG. 2.

If the packet is an outgoing packet (block 502), the packet is further evaluated to determine if the packet is from the replicated server instance, the server B 310, or the replica server instance, the server B′ 315 (block 510). Such an evaluation may be made, for example, by evaluating the source address and/or port of the packet. For example, the source address and/or port of the packet may be compared to a list of addresses and/or ports associated with the replica server instance, the server B′ 315. If the source address and/or port of the packet is not in the list, then the packet is not from the replica server, the server B 315. If the source address and/or port of the packet is in the list, then the packet is from the replica server, the server B 315.

If the packet is from the replicated server instance, the server B 310 (block 510, the packet is forwarded to the appropriate network (block 512) and/or process, for example, if the packet is to be encrypted. Optionally, the packet may be time stamped and cached (block 508), for example, in the network traffic cache 262 of FIG. 2. If the packet is from the replica server instance, the server B′ 315 (block 510, the packet is discarded (block 514) and is not forwarded to the appropriate network and/or process. Thus, network traffic and/or process load may be unaffected by the replication of the network traffic to the replica server, the server B′ 315. These operations may be repeated for each packet to/from the replicated server instance, the server B 310. Such a repetition may, for example, be carried out for a predefined time or may be provided for until subsequent operator intervention.

In embodiments of the present invention having different front-end and back-end proxies, the type of communication may also be evaluated in determining whether to forward the packet of discard the packet. For example, the front-end proxy could forward all incoming Hyper-text Transfer Protocol (HTTP) requests or responses and discard all outgoing HTTP responses from the replica server. Thus, an HTTP request from the replica server received by the front-end proxy could be forwarded to the network. The back-end proxy, however, could forward all incoming HTTP requests and response and discard all HTTP request from the replica server while forwarding HTTP responses from the replica server. Thus, the granularity of the forwarding and discard may be dependent on the particular server application being replicated and may vary from system to system. Accordingly, “forwarding” and “filtering” as used herein refers to both selective and non-selective forwarding and filtering.

The flowcharts and block diagrams of FIGS. 1 through 5 illustrate the architecture, functionality, and operation of possible implementations of systems, methods and computer program products for generating simulated Internet traffic according to various embodiments of the present invention. In this regard, each block in the flow charts or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be understood that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer instructions.

In the drawings and specification, there have been disclosed typical illustrative embodiments of the invention and, although specific terms are employed, they are used in a generic and descriptive sense only and not for purposes of limitation, the scope of the invention being set forth in the following claims.

That which is claimed is:

1. A method of replicating operation of an instance of a server application, comprising:
replicating the instance of the server application to provide a replica server;
forwarding to the replica server, network traffic to the instance of the server application from a network associated with the instance of the server application; and
filtering network traffic from the replica server so as to prevent network traffic from the replica server from reaching the network associated with the server.

2. The method of claim 1, further comprising forwarding to the instance of the server application, network traffic to the instance of the server application from the network associated with the instance of the server application.

3. The method of claim 1, further comprising storing the network traffic forwarded to the replica server.

4. The method of claim 3, wherein storing the network traffic forwarded to the replica server further comprises storing timing information associated with the network traffic.

5. The method of claim 4, further comprising playing back the stored network traffic to the replica server utilizing the stored timing.

6. The method of claim 1, further comprising:
selecting a debug mode for replication of the instance of the server application; and
wherein replicating the instance of the server application to provide a replica server, forwarding to the replica server, network traffic to the instance of the server application from a network associated with the instance of the server application and filtering network traffic from the replica server so as to prevent network traffic from the replica server from reaching the network associated with the server are automatically carried out if debug mode is selected.

7. The method of claim 1, further comprising:
modifying characteristics of the replica server without modifying characteristics of the instance of the server application; and
selectively propagating the modifications to the characteristics of the replica server to the instance of the server application based on an effect of the modifications on the operation of the replica server in response to the forwarded network traffic.

8. The method of claim 2, wherein forwarding to the replica server and forwarding to the instance of the server application, network traffic to the instance of the server application from the network associated with the instance of the server application and filtering network traffic from the replica server so as to prevent network traffic from the replicated server from reaching the network associated with the server comprises:
generating a proxy agent that receives network traffic from the network to the instance of the server application and forwards the received network traffic to the instance of the server application and the replica server and receives network traffic from the instance of the server application and the replica server, filters out the network traffic received from the replica server and forwards the network traffic received from the instance of the server application to the network.

9. The method of claim 8, wherein generating a proxy agent comprises:
generating a front-end proxy agent that forwards requests to the instance of the server application and the replica server and filters responses from the instance of the server application and the replica server; and
generating a back-end proxy agent that filters requests from the instance of the server application and the replica server and forwards responses to the instance of the server application and the replica server.

10. The method of claim 2, wherein forwarding to the replica server and forwarding to the instance of the server application, network traffic to the instance of the server application from the network associated with the instance of the server application and filtering network traffic from the replica server so as to prevent network traffic from the replica server from reaching the network associated with the server comprises:
forwarding requests to the instance of the server application to the replica server and the instance of the server application;
forwarding responses to requests from the instance of the server application to the replica server and the instance of the server application; and
filtering out responses from the replica server and requests from the replica server.

11. The method of claim 2, wherein forwarding to the replica server and forwarding to the instance of the server application, network traffic to the instance of the server application from the network associated with the instance of the server application is preceded by security processing the network traffic so as to provide unencrypted network traffic; and
wherein forwarding to the replica server and forwarding to the instance of the server application, network traffic to the instance of the server application from the network associated with the instance of the server application comprises forwarding to the replica server and to the instance of the server application, the unencrypted network traffic.

12. The method of claim 1, wherein filtering network traffic from the replica server so as to prevent network traffic from the replica server from reaching the network associated with the server comprises filtering network traffic from the replica server prior to security processing of the network traffic from the replica server.

13. A system for replicating operation of all instance of a server application, comprising:
a replica of the instance of the server application; and
a proxy configured to receive network traffic to the instance of the server application and to forward network traffic to the instance of the server application to the replica of the instance of the server application and to receive network traffic from the replica of the instance of the server application and filter out network traffic from the replica of the instance of the server application.

14. The system of claim 13, wherein the proxy is further configured to store the network traffic forwarded to the instance of the server application.

15. The system of claim 14, wherein the proxy is further configured to store timing information associated with the stored network traffic.

16. The system of claim 13, wherein the proxy comprises:
a front-end proxy configured to forward requests to the instance of the server application and the replica of the server application and filter responses from the instance of the server application and the replica of the instance of the server application; and
a back-end proxy configured to filter requests from the instance of the server application and the replica of the instance of the server application and forward responses to the instance of the server application and the replica of the instance of the server application.

17. A system replicating operation of an instance of a server application, comprising:
means for replicating the instance of the server applications to provide a replica server;
means for forwarding to the replica server, network traffic to the instance of the server application from a network associated with the instance of the server application; and
means for filtering network traffic from the replica server so as to prevent network traffic from the replica server from reaching the network associated with the server.

18. The system of claim 17, further comprising means for forwarding to the instance of the server application, network traffic to the instance of the server application from the network associated with the instance of the server application.

19. A computer program product for replicating operation of an instance of a server application, comprising:
a computer readable medium having computer readable program code embodied therein, the computer readable program code comprising:
computer readable program code configured to replicate the instance of the server application to provide a replica server;
computer readable program code configured to forward to the replica server, network traffic to the instance of the server application from a network associated with the instance of the server application; and
computer readable program code configured to filter network traffic from the replica server so as to prevent network traffic from the replica server from reaching the network associated with the server.

20. The computer program product of claim 19, further comprising computer readable program code configured to forward to the instance of the server application, network traffic to the instance of the server application from the network associated with the instance of the server application.
